(19) United States
(12) Patent Application Publication
(10) Pub. No.: US 2004/0178030 A1
(43) Pub. Date: Sep. 16, 2004

(54) Disk-brake disk with air cooling

(76) Inventors: Giovanni Paolo Pacchiana, Locate (IT); Guido Perricone, Bergamo (IT)

Correspondence Address: Robert M Haroun, Sofer & Haroun, Suite 910, 317 Madison Avenue, New York, NY, 10017, US

(21) Appl. No.: 10/480,174

(22) PCT Filed: Jun. 13, 2001
(86) PCT No.: PCT/IT01/00302

(51) Int. Cl. F16D 65/10

(52) U.S. Cl. 188/218 XL; 188/18 A

(57) ABSTRACT

A disk-brake disk with air cooling comprises a bell (2), an annular braking band (4), coupling means (6, 9, 61, 68, 33, 34) between the bell and the braking band, and ventilation means. In order to cool the disk effectively without the use of complex structures, the ventilation means comprise a plurality of fins (68a) which project from the plane of at least one of the braking surfaces of the annular braking band (4) in the vicinity of the inner edge of the band.

The present invention relates to disk brakes and, more particularly, to a disk-brake disk with air cooling as defined in the preamble of Claim 1.

A disk brake of the type used as a braking device in motor vehicles comprises an annular, cast-iron portion, commonly known as the braking band, which is usually integral with a hub, commonly known as the bell, and is connected to a wheel of the vehicle, and a caliper which is fixed to the hub-carrier, extends around the braking band and is provided with brake linings or pads. The caliper acts on the pads by means of an hydraulic actuation, so as to bring them into contact with the two opposed braking surfaces of the braking band. If the wheel with its bell and braking-band unit is rotating, the operation of the caliper brings about a braking effect due to the friction between the pads and the braking surfaces of the braking band, with consequent heating of the disk, that is, of the bell and the braking band as a whole. As is known, this heating leads to undesired deformation due to the difference in temperature between the band and the bell. To overcome this disadvantage, and to produce high-performance braking devices, disks in which the braking band and the bell are formed by two separate parts made of different materials and connected to one another by suitable coupling means have been proposed.

The materials which may be used for the manufacture of the braking band are composite materials, for example, carbon/silicon carbide (C/SiC) and those which may be used for the manufacture of the bell are metals such as steel, cast iron, aluminium alloys, titanium, etc. Although the materials used for the braking band have the required characteristics of resistance both to wear and to high temperatures and a low specific weight, they are quite fragile and their machining requires special tools and precautions. The connection between the braking band and the bell cannot therefore be made with the use of conventional coupling means such as pins, screws, etc. Moreover, the different coefficients of thermal expansion of the two materials requires that the restraint achieved by the couplings should not be too rigid.

In a disk of this type, as will be described in greater detail below, the bell has a plurality of radial teeth and the braking band has a corresponding plurality of radial recesses. The fitting of the teeth in the recesses achieves a coupling which ensures a tangential restraint between the two parts. The axial restraint between the two parts is ensured by plates which are fixed to the teeth of the bell by bolts and which extend around the portions of the braking band that are defined between adjacent radial recesses. To avoid too rigid a restraint and to ensure a uniform distribution of the load transmitted by a braking action, inserts in the form of suitably shaped plates are disposed between the teeth of the bell and the recesses of the braking band.

Disks which use braking bands made of the alternative materials indicated above reach very high temperatures during braking, particularly after repeated braking cycles as occurs, in practice, for example, during a descent. The disks are generally “solid” since they cannot be shaped to favour their ventilation as is done with disks made of conventional materials, for example, cast iron. Tests performed with C/SiC disks having through ventilation ducts have not led to satisfactory results because of the low coefficient of thermal conductivity of the material and of the limitations on the cross-section and on the extent of the ducts imposed by the geometrical characteristics required by the coupling with the bell.

The overheating problem relates not so much to the disk, since the material of which it is made can withstand even very high temperatures, but rather to other components of the brake, particularly the fluid of the braking system which risks reaching boiling point.

The aim of the invention is to propose a disk-brake disk of the type described above in which ventilation means which are effective and at the same time simple in structure and easy to fit are provided.

This aim is achieved by the provision of the disk which is defined and characterized in general in Claim 1 and specific embodiments of which are defined in the dependent claims.

The invention will be understood better from the following detailed description of some embodiments thereof given by way of non-limiting example with reference to the appended drawings, in which:

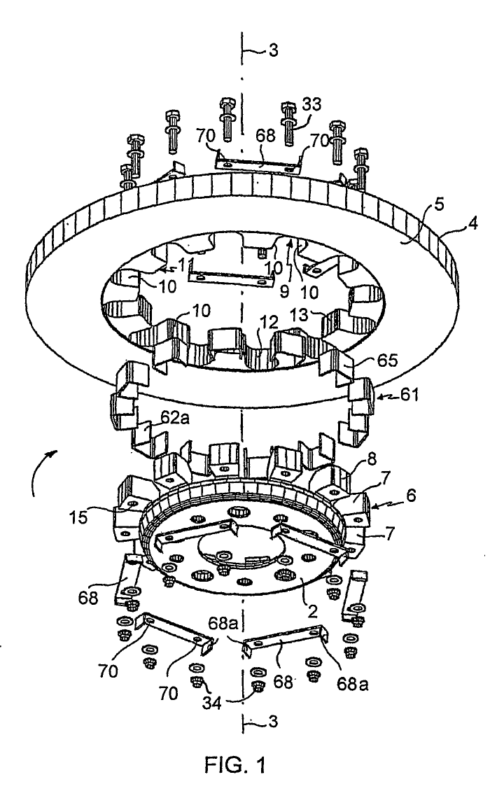

FIG. 1 is an axonometric view of a disk-brake disk according to the invention, with parts separated,

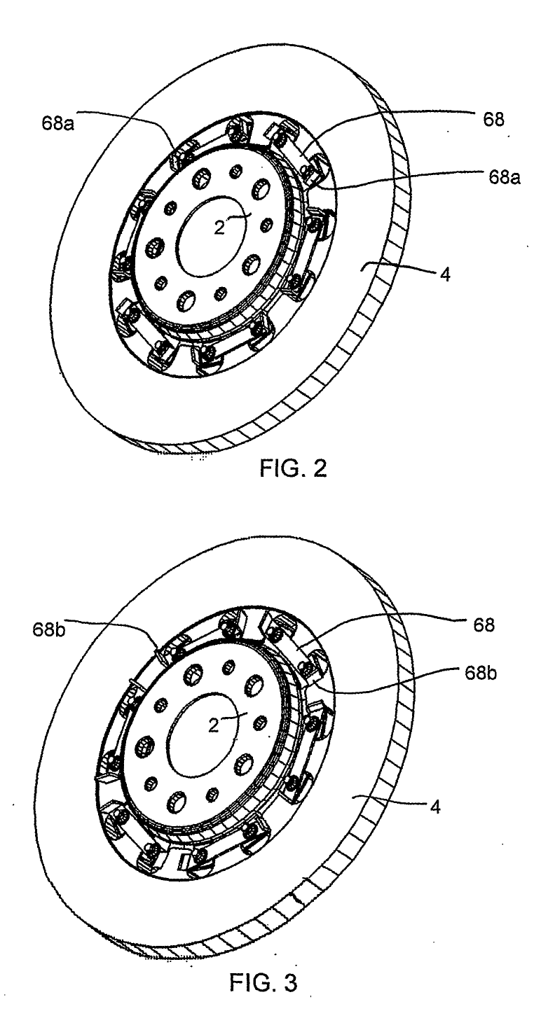

FIG. 2 is an axonometric view of the disk of FIG. 1, after assembly,

FIGS. 3 to 9 are axonometric views of further embodiments of the disk according to the invention, and

FIG. 9a shows an insert used in the disk of FIG. 9, in perspective and on an enlarged scale.

With reference to FIGS. 1 and 2, a disk according to the present invention comprises a bell 2 having an axis of rotation 3 and a braking band 4 having two opposed braking surfaces 5. The bell 2 may be made of hard anodized aluminium alloy or of sintered steel and the braking band 4 may be made of a composite material, for example, carbon/silicon carbide.

The bell 2 has an outer set of teeth constituted by a plurality of radial teeth 6, preferably spaced apart uniformly and having sides 7 which are connected by a head surface 8. Each radial tooth 6 has a through-hole 15 through which a screw 33 can extend. The braking band 4 has a plurality of corresponding radial recesses 9. The tangential restraint between the bell 2 and the braking band 4 is achieved by inserting the teeth 6 of the bell 2 in the recesses 9 of the braking band 4, after the interposition of generally U-shaped inserts 61 constituted by plates of yielding material, for example, drawing steel. Each of the inserts 61 has a profile substantially complementary to that of a tooth 6 of the bell 2, with a base 65 and two substantially identical arms 62a, and can be fitted in a corresponding recess 9 of the braking band 4 so that the arms 62a interfere with the opposed sides 10 of the recess.

The disk also has a plurality of elongate plates 68 arranged in circular series on its two opposed sides. Each plate 68 has two holes 70 spaced apart in a manner such that each is aligned with respective holes 15 of two adjacent teeth 6 and can extend around a portion of the braking band 4 defined by two adjacent radial recesses (FIG. 2). The plates 68 of one side alternate with the plates 68 of the opposite side so as to ensure an axial restraint between the bell 2 and the braking band 4 when the screws 33 are screwed into respective nuts 34. Each plate 68 has its ends bent at right angles along lines perpendicular to its longer sides to form two fins 68a.

In order to assemble the disk, the U-shaped inserts 61 are inserted in the corresponding recesses 9 in a manner such that the outer surfaces of the arms 62a interfere with the sides 10 of the recesses 9. The radial teeth 6 of the bell 2 are then inserted in the recesses between the arms of the inserts, forming the tangential coupling between the bell 2 and the braking band 4. Finally, the plates 68 are arranged in circular series with their fins 68a facing outwardly, the screws are inserted in the holes 70 in the plates and in the holes 15 in the teeth of the bell, and the nuts are screwed onto the screws.

The structure shown in FIG. 2 is thus obtained, that is, a disk in which the bent ends 68a of the axial restraint plates 68 project from the planes of the two braking surfaces of the braking band 4, forming two rings of ventilation fins (only one of which is visible in FIG. 2) along the inner edge of the band.

In this embodiment, the fins 68a project perpendicularly from the braking surface, but they could also be bent at angles other than right angles if that were advantageous for improving the ventilation effect of the disk during its rotation.

Moreover, the orientation of the fins which, in the embodiment of FIG. 1, is that which results from the bending of the ends of the plate along lines perpendicular to the longer sides of the plate, could be different, for example, radial, as shown in FIG. 3, in which the fins are indicated 68b.

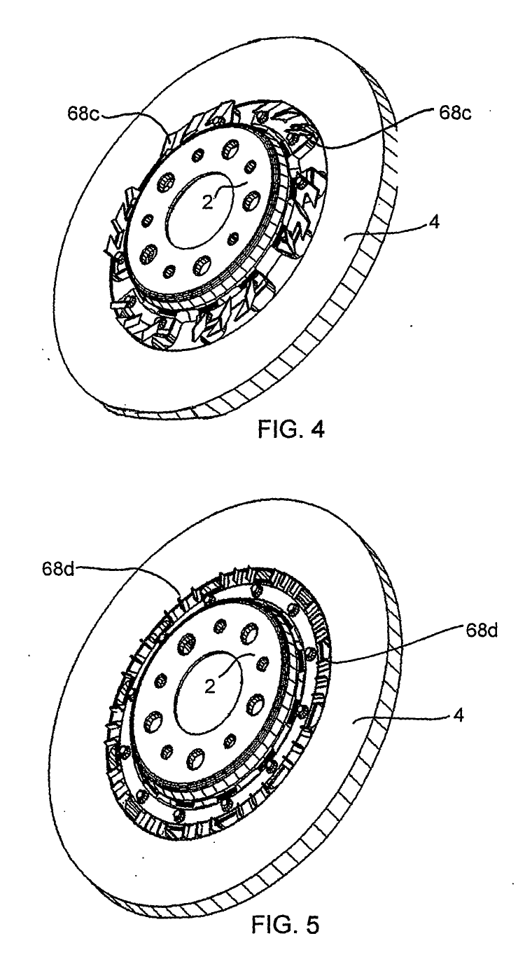

According to another embodiment of the invention shown in FIG. 4, the axial restraint plates are substantially quadrangular and, more precisely, are formed as sectors of circular rings in which the side facing the bell 2 performs the restraint function and the side facing the band 4 has fins 68c produced by cutting and bending. The bending line is such that the fins 68c are oriented at a uniform angle to the radii of the disk.

According to yet another embodiment, shown in FIG. 5, the axial restraint elements comprise annular plates, of which there is one on each face of the disk, and in which radial fins 68d are formed by cutting and bending in the side facing the band.

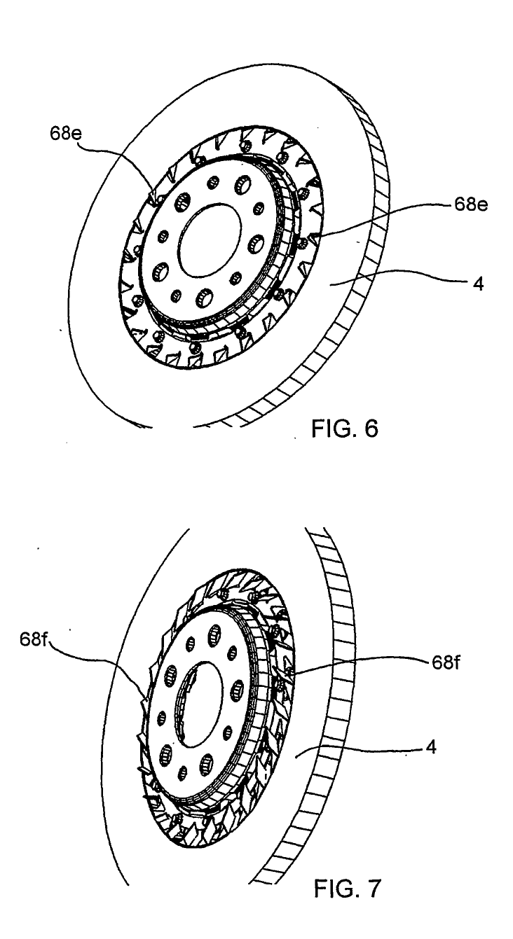

FIGS. 6 and 7 show another two embodiments of annular restraint plates, one with triangular fins 68e formed by radial cutting and bending at uniform angles to the radii and the other with rectangular fins 68f formed by a circular ring outside the circular ring of the annular restraint plate, with L-shaped cutting and bending along a line inclined to the radius.

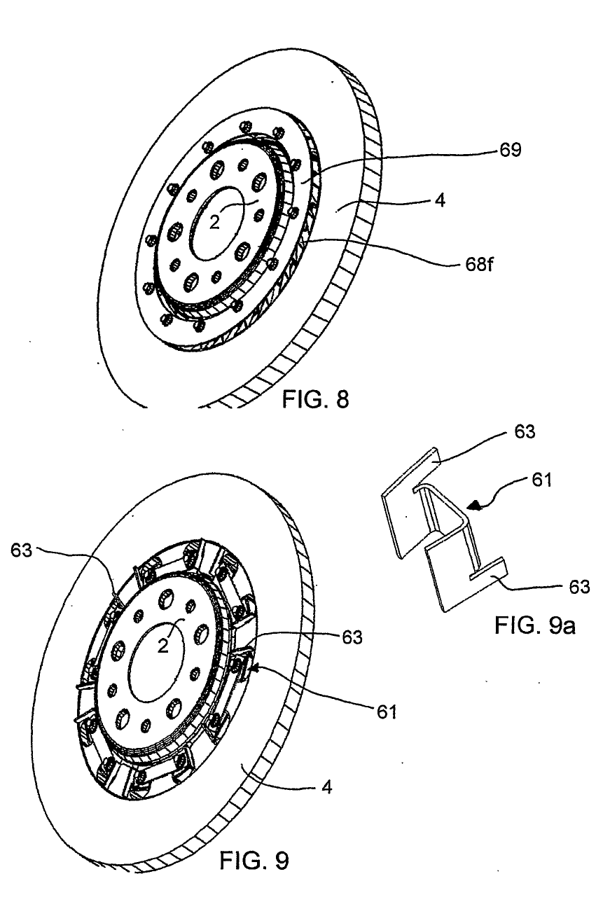

FIG. 8 shows an embodiment in which the fins are formed as in the embodiment of FIG. 7 but in which an annular plate 69 closes the tops of the spaces defined by the fins 68f so as to form a plurality of true ventilation ducts. The annular cover plate 69 is fixed by the same screws which serve to fix the annular restraint plates. Suitable spacers, for example, bushes (not visible in the drawings), which surround the screws, are provided between the annular restraint plate and the annular cover plate.

FIG. 9 shows an embodiment of the invention in which the inserts for adaptation between the teeth 6 of the bell 2 and recesses 9 of the band 4, again indicated 61, are shaped in a manner such that each has two fins 63 projecting from the planes of the braking surfaces of the disk. The inserts 61 of FIG. 9 differ from the U-shaped inserts 61 of FIG. 1 in that the arms of the U-shaped plates are extended laterally as shown in FIG. 9a, each forming a fin 63 on one face of the disk and another fin on the opposite face.

As is clear from the foregoing description, the disk according to the invention can be produced practically without modification of the basic structure of a disk of the type constituted by a bell and a braking band in two separate parts, but simply by applying small modifications to the coupling elements between the two parts. However, these small modifications achieve significant advantages in terms of efficiency. In fact, comparative tests between a disk with a steel bell and a carbon/silicon carbide braking band without ventilation fins and an identical disk but modified in accordance with the invention showed that the operating temperatures were significantly lower in the disk according to the invention, for given operating conditions.

Although only some specific embodiments of the invention have been described and illustrated, clearly many variations and modifications are possible within the scope of the same inventive concept. For example, the ventilation fins could be provided on only one face of the disk rather on both faces, or some of the ventilation fins could be formed by restraint plates similar to those of FIGS. 2, 3 or 4 and some by adaptation inserts such as those of the embodiment of FIG. 9.

1. A disk-brake disk with air cooling, comprising a bell (2), an annular braking band (4), coupling means (6, 9, 61, 68, 33, 34) between the bell and the braking band, and ventilation means, characterized in that the ventilation means comprise a plurality of fins (68a, 63) which project from the plane of at least one of the braking surfaces of the annular braking band (4) in the vicinity of the inner edge of the band.

2. A disk according to claim 1 in which the coupling means comprise axial restraint means (68, 33, 34), and in which at least some (68a) of the fins (68a, 63) are formed integrally with elements (68) of the axial restraint means.

3. A disk according to claim 2 in which the elements of the axial restraint means comprise at least one plate (68) and the fins integral with the elements are formed by bent portions (68a-68f) of the plate or plates.

4. A disk according to claim 3 in which the plates are elongate and the bent portions of the plates which form the fins are end portions (68a, 68b) of the elongate plates.

5. A disk according to claim 3 in which the plates are substantially quadrangular.

6. A disk according to any one of claims 1 to 5 in which the coupling means comprise tangential restraint means (6, 9, 61) with adaptation inserts (61), and in which at least some (63) of the fins (68a, 63) are formed integrally with the adaptation inserts (61).

7. A disk according to claim 3 in which the elements of the axial restraint means comprise at least one annular plate.

8. A disk according to claim 7, comprising an annular cover plate which is associated with the or with each annular plate having the fins and is arranged parallel thereto so as to close the tops of the spaces defined by the fins (68f).

9. A disk according to any one of the preceding claims in which the fins are substantially perpendicular to the plane of the braking surface.

10. A disk according to any one of the preceding claims in which the fins are oriented radially.

11. A disk according to any one of the preceding claims in which the fins are oriented at a predetermined angle to the radial direction.
